(19) United States
(12) Patent Application Publication
(10) Pub. No.: US 2014/0091990 A1
(43) Pub. Date: Apr. 3, 2014

(54) HEAD-MOUNTED DISPLAY SYSTEM

(71) Applicant: WISTRON CORPORATION, New Taipei City (TW)

(72) Inventor: Yao-Tsung Chang, New Taipei City (TW)

(73) Assignee: Wistron Corporation, New Taipei City (TW)

(21) Appl. No.: 13/888,387

(22) Filed: May 7, 2013

(30) Foreign Application Priority Data
Oct. 1, 2012 (TW) 101136241

(51) Int. Cl. G02B 27/01

(52) U.S. Cl. CPC G02B 27/0172
USPC 345/8

(57) ABSTRACT

A head-mounted display system for a user to wear is provided. The head-mounted display system comprises a display unit and display pointing unit. The display unit has a display surface facing a face of the user and the display unit is comprised of several pixels. Each of the pixels emits an image beam. The display pointing unit is configured on the display surface of the display unit and the display pointing unit shrinks the image beams from the pixels and directs the image beam towards a pupil of at least one of the eyes of the user.

### CROSS-REFERENCE TO RELATED APPLICATION

This application claims the priority benefit of Taiwan application serial no. 101136241, filed on Oct. 1, 2012. The entirety of the above-mentioned patent application is hereby incorporated by reference herein and made a part of this specification.

### BACKGROUND OF THE INVENTION

1. Field of Invention

The present invention relates to a display system. More particularly, the present invention relates to a head-mounted display system.

2. Description of Related Art

The process for forming object image on the retina of human eyeball includes that the lights of object passes through the cornea and the pupil (which serves much the same function as the diaphragm of the camera) and reaches the crystalline lens (which serves much the same function as the lenses of the camera). The lights of the object are focused on the retina by the crystalline lens. Herein, the image on the retina is an upside-down real image and the optic nerves on the retina sense the lights (the object image) to generate signals and then to transmit the signals to the brain. Thereafter, the brain generates the image of the object.

Generally, the best reading distance is about 22˜30 centimeters. The crystalline lens is a structure capable of adjusting the focal length thereof. Therefore, when a person watches an object far away from him/her, the crystalline lens of the person is at a natural state. Further, when the person watches the object in a very close distance, the crystalline lens is controlled by the ciliary muscle to adjust the focal length thereof so that the image of the object in a very close distance can be clearly form on the retina. If the person perceives the object in a very close distance for a long time, the eyesight is easy to be damaged. However, the head-mounted display system is a display device very close to the eyes of the user. When wearing the head-mounted display system to watch the images for a long time, the user easily feels tired and the eyesight of the user is easy to be damaged.

### SUMMARY OF THE INVENTION

The invention provides a head-mounted display system capable of providing the user a clear image without making the users eye uncomfortable even the display unit is very close to the eye of the user.

The invention provides a head-mounted display system for a user to wear on. The head-mounted display system comprises a display unit and a display pointing unit. The display unit has a display surface facing a face of the user and is comprised of a plurality of pixels and each of the pixels emits an image beam. The display pointing unit is configured on the display surface of the display unit, wherein the display pointing unit shrinks the image beams from the pixels and directs the shrunk image beam towards a pupil of at least one of eyes of the user.

According to one embodiment of the present invention, the display pointing unit comprises a plurality of pointing structures and each of the pointing structures corresponds to at least one of the pixels.

According to one embodiment of the present invention, each of the pointing structures comprises a shielding structure for shielding a portion of the image beams from the corresponding pixel.

According to one embodiment of the present invention, each of the pointing structures further comprises a column-type directing structure arranged to be corresponding to the shielding structure of the pointing structure and each of the column-type directing structure directs the image beam passing through the corresponding shielding structure to the pupil of the at least one of the eyes of the user.

According to one embodiment of the present invention, the column-type directing structures have different pillar heights and pillar top surfaces of the column-type directing structures have different inclinations to the display surface according to the arranging positions of the corresponding pixels on display unit.

According to one embodiment of the present invention, the pillar top surfaces of the column-type directing structure together form a pointing unit top surface of the display pointing unit and there is an inclination angle between the pointing unit top surface and the display surface.

According to one embodiment of the present invention, each of the shielding structure shields the portion of the image beams from the corresponding pixel so that rest portion of the image beams with a particular light traveling direction passes through the shielding structure.

According to one embodiment of the present invention, a portion of the image beams passing through the shielding structures have different particular light traveling directions according to arranging positions of the corresponding pixels on display unit.

According to one embodiment of the present invention, each of the particular light traveling directions points to the pupil of the at least one of the eyes of the user.

According to one embodiment of the present invention, each of the shielding structures includes a liquid crystal structure.

According to one embodiment of the present invention, the aforementioned head-mounted display system further comprises a pupil position detector and a controller. The pupil position detector is used for detecting a pupil position of the at least one of the eyes of the user. The controller is connected to the display pointing unit and the pupil position detector, wherein, according to the pupil position detected by the pupil position detector, a lattice orientation of each of the liquid crystal structures of the display pointing unit is controlled so that a portion of the image beams passing through each of the liquid crystal structures respectively points to the pupil of the at least one of the eyes of the user.

According to one embodiment of the present invention, each of the pointing structures includes a lens for focusing the image beam from the corresponding pixel and directing the focused image beam to the pupil of the at least one of the eyes of the user.

According to one embodiment of the present invention, a scattering angle of each of the image beams passing through each of the pointing structures is smaller than 0.1 degree.

In the display unit of the present invention, before entering the user pupil of the user, the image beam emitted from each of the pixels is optically processed by the display pointing unit so that the image beam is shrunk and the scattering angle of each of the image beam is within a particular range. Further, the light traveling direction of each of the image beams which have been optically processed is toward the user pupil. Then, after being refracted by the crystalline lens of the user, the shrunken image beams compose a distinct image on the retina. Therefore, although the distance between the display unit of the head-mounted display system 100 and the eyeball of the user is short, the user can still receive the clear image and there is no need to adjust the focal length of the crystalline lens. Hence, the user will not feel tired or even suffers from eye injury by using the head-mounted display system for a long time.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing showing a head-mounted display system according to one embodiment of the invention.

FIG. 2 is a schematic cross-sectional diagram showing a display unit and a display pointing unit according to one embodiment of the invention.

FIG. 3A is a schematic cross-sectional diagram showing a display unit and a display pointing unit according to another embodiment of the invention.

FIG. 3B is a schematic cross-sectional diagram showing a display unit and a display pointing unit according to the other embodiment of the invention.

FIG. 3C is a schematic cross-sectional diagram showing a display unit and a display pointing unit according to one embodiment of the invention.

FIG. 3D is a schematic cross-sectional diagram showing a display unit and a display pointing unit according to one embodiment of the invention.

FIG. 4 is a schematic cross-sectional diagram showing a display unit and a display pointing unit according to another embodiment of the invention.

FIG. 5 is a schematic cross-sectional diagram showing a display unit and a display pointing unit according to the other embodiment of the invention.

FIG. 6A is a schematic diagram showing the light of the image strikes the retina of the eye through the pupil to form image on the retina.

FIG. 6B is a schematic diagram showing the light of the image passes through the display pointing unit and then strikes the retina of the eye through the pupil to form image on the retina according to one embodiment of the invention.

### DESCRIPTION OF THE PREFERRED EMBODIMENTS

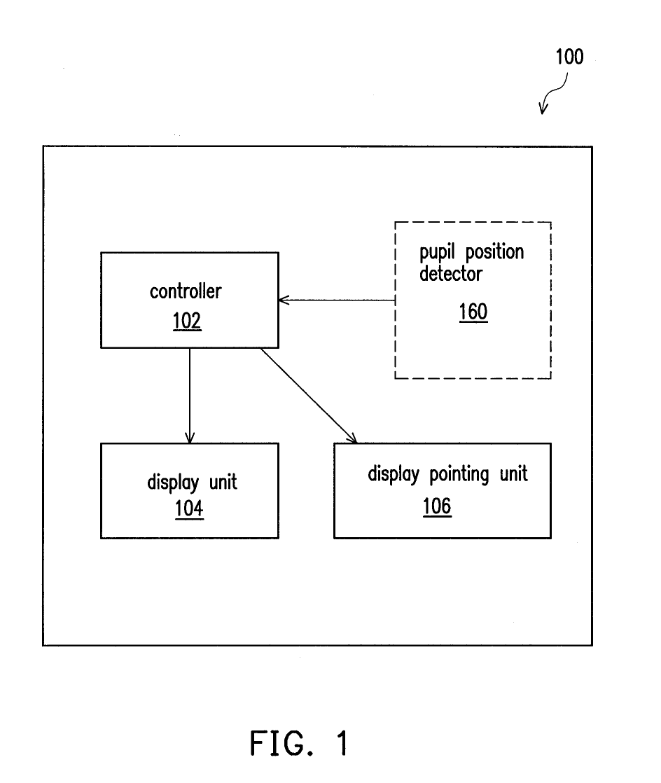

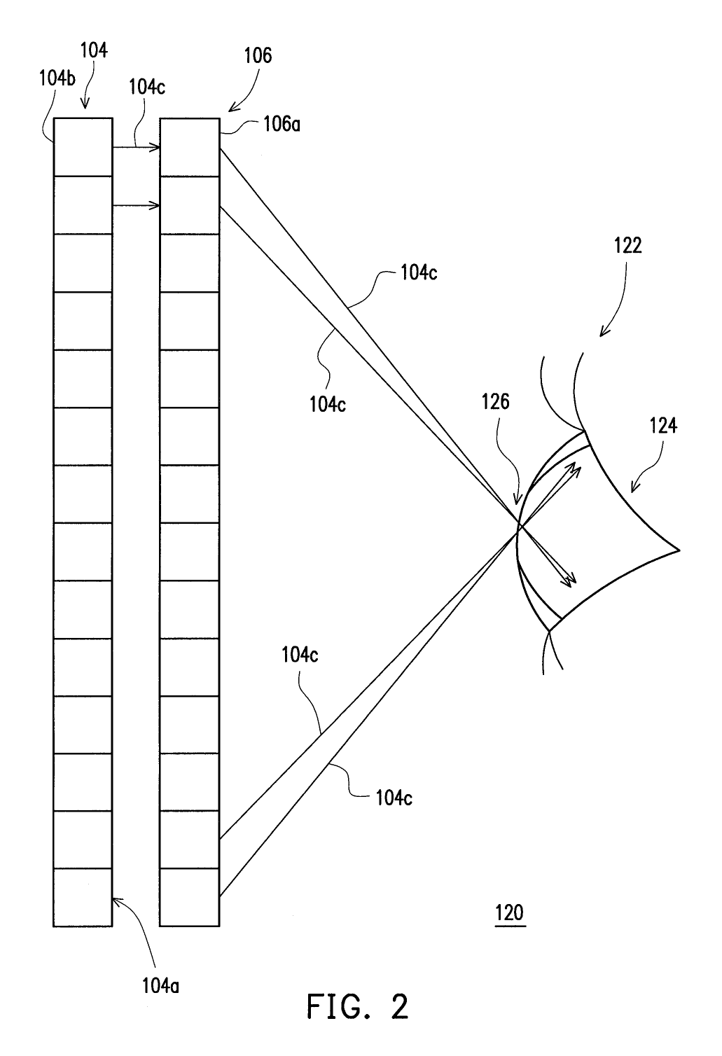

FIG. 1 is a schematic drawing showing a head-mounted display system according to one embodiment of the invention. FIG. 2 is a schematic cross-sectional diagram showing a display unit and a display pointing unit according to one embodiment of the invention. As shown in FIG. 1, the head-mounted display system 100 of the present embodiment comprises a controller 102, a display unit 104 and a display pointing unit 106. The head-mounted display system 100, for example, is configured on a supporting frame (such as the eyeglass frame). The supporting frame uses a middle supporting structure and two extending arm structures respectively connecting ends of the middle supporting structure to be respectively mounted on the nose and the ears of the user so that it makes sure that the supporting frame can be securely mounted on the head of the user. In one embodiment, the head-mounted display system 100 can be, for example, disposed on the middle supporting structure of the supporting frame and near one end of the middle supporting structure. That is, the head-mounted display system 100 is disposed to be close to one of the eyes of the user and the distance between the head-mounted display system 100 and the closest eye is about 2˜10 centimeters. Moreover, the controller 102 can be, for example, a central processing unit or a micro processing controller. The controller 102 is coupled to the display unit 104 to control the display unit 104 for displaying images.

As shown in FIG. 1 and FIG. 2, the display unit 104 has a display surface 104a facing a face 122 of the user 120. It should be noticed that the display unit 104 is comprised of several pixels 104b and each of the pixels 104b emits an image beam 104c. Each of the image beams 104c, for example, is a parallel beam.

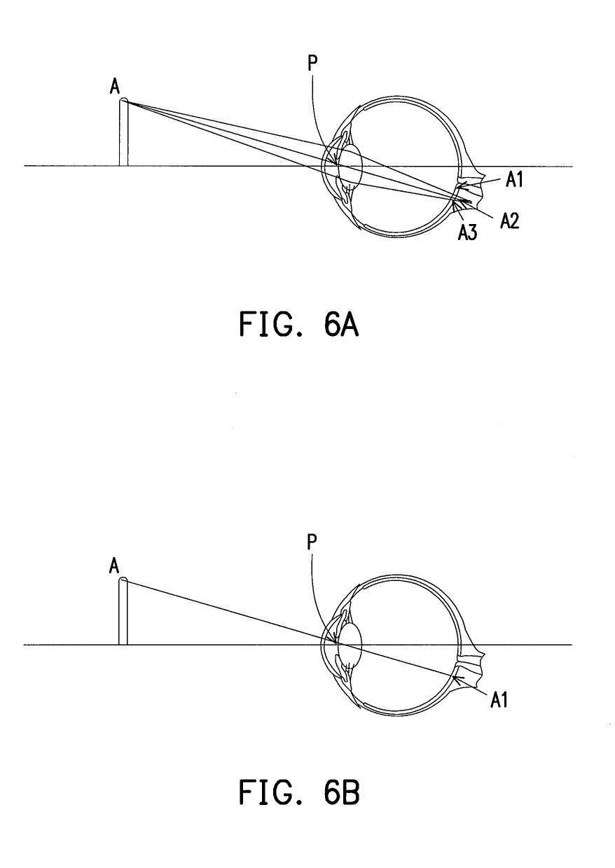

The display pointing unit 106 is configured on the display surface 104a of the display unit 104. The display pointing unit 106, for example, is configured on the display surface 104a of the display unit 104 in a way of attaching method. The attaching method comprises air bonding or direct bonding. Moreover, the display pointing unit 106 shrinks the image beams 104c from the pixels 104b and directs the shrunk image beams 104c to a pupil 126 of at least one of the eyes 124 of the user 120. That is, after the image beam 104c from each of the pixels 104b is optically processed by the display pointing unit 106, the image beams 104c′ from the display pointing unit 106 is directed to the pupil 126 of at least one of the eyes 124 of the user 120. FIG. 6A is a schematic diagram showing the light of the image strikes the retina of the eye through the pupil to form image on the retina. As shown in FIG. 6A, the scattering light beams of the image A without being processed by the display pointing unit pass through the pupil P and strike the retina to form images A1, A2 and A3 within a region of the retina. FIG. 6B is a schematic diagram showing the light of the image passes through the display pointing unit and then strikes the retina of the eye through the pupil to form image on the retina according to one embodiment of the invention. As shown in FIG. 6B, after the lights of the image A is processed by the display pointing unit, the lights of the image A is focused to be a convergent light beam to pass through the pupil P. Therefore, the convergent light beam of the image A forms a single point image A1 on the retina. In other words, the display pointing unit shrinks the image beams 104c from the pixels 104b (i.e. the scattering angle of the image beam is decreased) so that the focusing efficiency of the image on the retina can be greatly improved. Thus, the focusing is more accurate and the image on the retina is more clear. For instance, when the distance between the object (image) and the eyeball is about 20 millimeters, the scattering angle of the light beam is smaller than 0.1 degree and the diameter of the pupil in reading activity is about 3 millimeters, diameter of the light beam projected through the pupil is about 0.03 millimeters and the focusing efficiency is improved for about a hundred times.

Noticeably, the display pointing unit 106 has several pointing structures 106a and each of the pointing structures 106a is arranged to be corresponding to at least one pixel 104b. In another embodiment, each of the pointing structures 106a is arranged to be corresponding to at least one of three-primary-color sub-pixels of one pixel 104b.

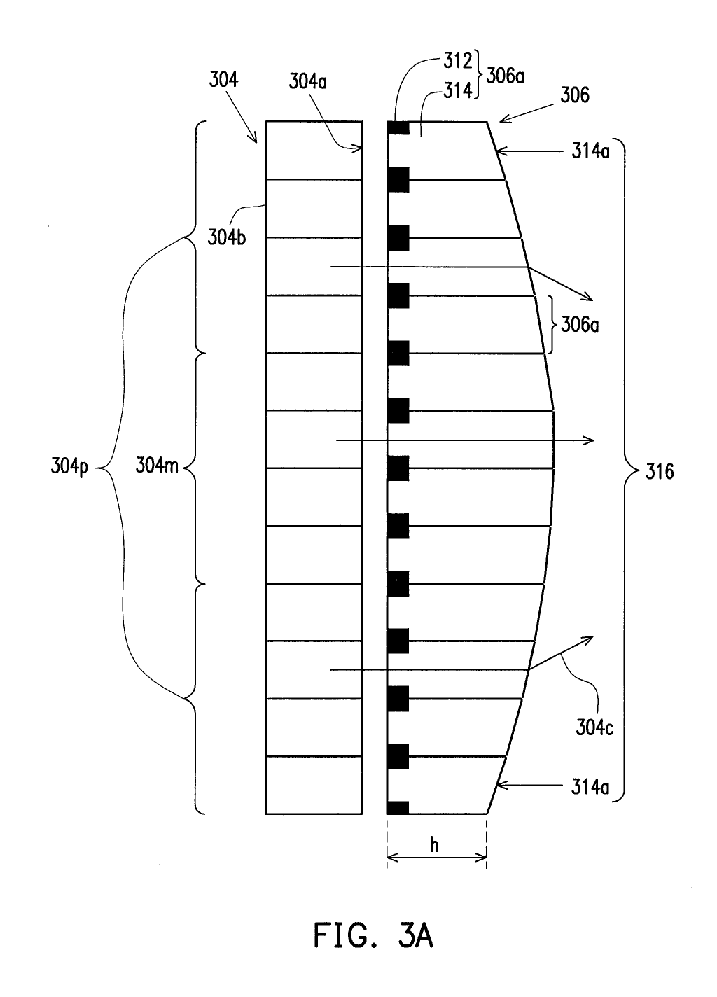

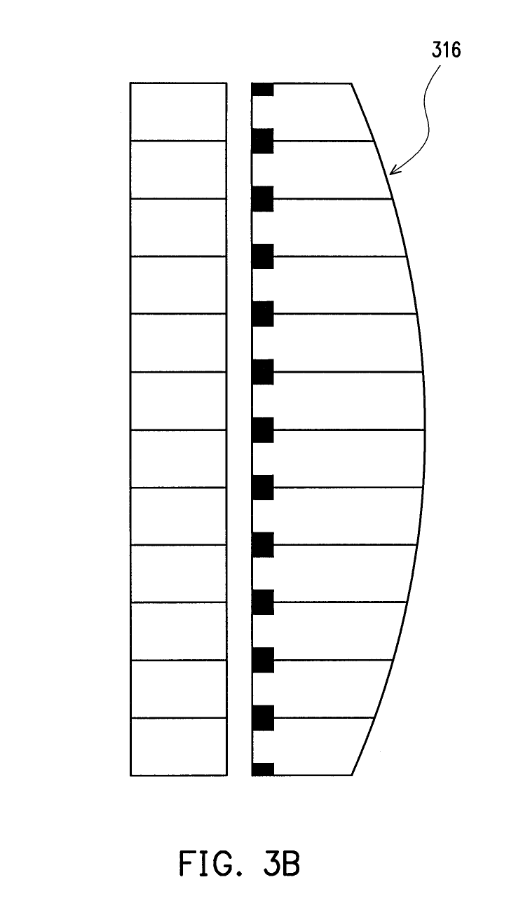

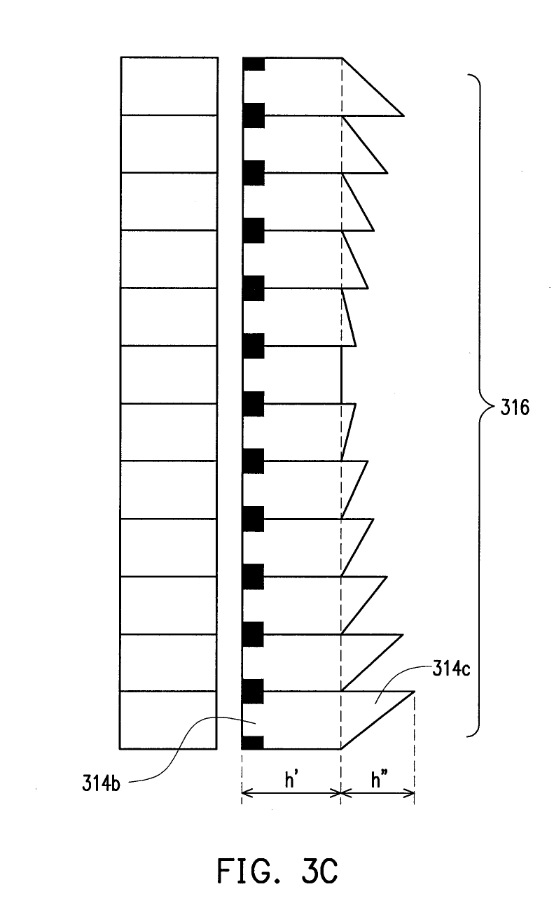

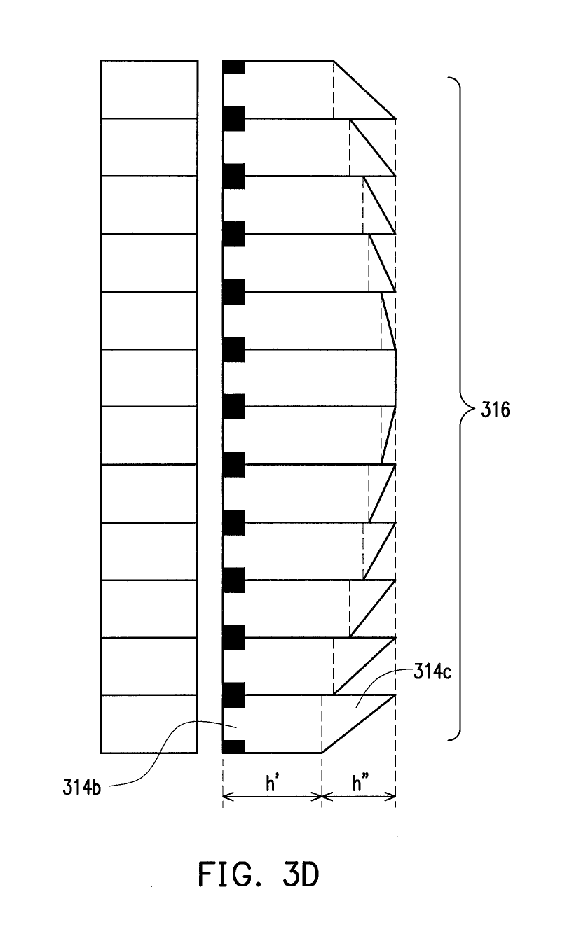

FIG. 3A is a schematic cross-sectional diagram showing a display unit and a display pointing unit according to another embodiment of the invention. As shown in FIG. 3A, in the present embodiment, each of the pointing structures 306a comprises a shielding structure 312 for shielding a portion of the image beam 304c from the pixel 304b corresponding to the pointing structure 306a. That is, the image beam 304c from the pixel 304b corresponding to the pointing structure 306a is shrunk to be within a particular range. For instance, the scattering angle of each of the image beams which have passed through the corresponding pointing structure 306a is smaller than 0.1 degree. In addition, in another embodiment, each of the pointing structures 306a further comprises a column-type directing structure 314 which is arranged to be corresponding to the shielding structure 312 of the pointing structure 306a. It should be noticed that, each of the column-type directing structures 314 directs the image beam which has passed through the corresponding shielding structure 312 to the pupil of at least one of the eyes of the user. In other words, by using the refraction effect due to light passing through different transmission medium, a portion of the image beams passing through the shielding structures 312 is refracted to be directed to the pupil of at least one of the eyes of the user.

Moreover, the column-type directing structures 314 have different pillar heights h according to the arrangement positions of the corresponding pixels 304b on the display unit 304. Also, each of the pillar top surfaces 314a of the column-type directing structures 314 inclines to nearest end of the display pointing unit 306 and the pillar top surfaces 314a of the column-type directing structures 314 have different inclinations (that is the included angle between the pillar top surface 314a and the display surface 304a) to the display surface according to arranging positions of the corresponding pixels on display unit. In one embodiment, the pillar top surfaces 314a of the column-type directing structures 314 together form a pointing unit top surface 316 of the display pointing unit 306 and the pointing unit top surface 316 is a convex surface, wherein the more protrudent the convex surface is, the closer to the central region 304m of the display unit 304 is. Further, there is an inclination angle between the convex surface between the display surface 304a.

It should be noticed that, according to different shapes of the column-type directing structures 314 (including pillar heights and the inclinations of the pillar top surfaces 314a of the column-type directing structure 314 from which the image beams emit), the image beams emitting from pixels at different arrangement positions have different light traveling distances in the column-type directing structure 314 and the image beams emitting from pixels at different arrangement positions and entering the atmosphere through the column-type directing structures 314 have different incident angles. Thus, the image beams from pixels at different arrangement positions are shrunk and directed to the pupil of at least one of the eyes of the user.

In the embodiment shown in FIG. 3A, as for the pointing structures 306a corresponding to the pixels 304b arranged at the peripheral region 304p of the display unit 304, the pillar heights h of the column-type directing structures 314 of the pointing structures 306a are relatively small. Moreover, as for the pointing structures 306a corresponding to the pixels 304b arranged at the central region 304m of the display unit 304, the pillar heights h of the column-type directing structures 314 of the pointing structures 306a are relatively large. Also, as for the pointing structures 306a corresponding to the pixels 304b arranged at the peripheral region 304p of the display unit 304, the pillar top surfaces 314a of the column-type directing structures 314 have relatively large inclinations to the display surface 304a (The is, the pillar top surfaces 314a of the column-type directing structures 314 having large inclinations to the display surface 304a leads to large incident angles of the image beams emitting from the column-type directing structures 314 so that the image beams emitting from the column-type directing structures 314 can be directed to the pupil or the position near the pupil center.). As for the pointing structures 306a corresponding to the pixels 304b arranged at the central region 304m of the display unit 304, the pillar top surfaces 314a of the column-type directing structures 314 have relatively small inclinations to the display surface 304a.

In other words, in the present embodiment, the heights of the column-type directing structures 314 increase with the arrangement positions of the corresponding pixels 304b from the peripheral region 304p of the display unit 304 to the central region 304m of the display unit 304. Further, the inclinations of the pillar top surfaces 314a of the column-type directing structures 314 decrease with the arrangement positions of the corresponding pixels 304b from the peripheral region 304p of the display unit 304 to the central region 304m of the display unit 304.

However, the height of the column-type directing structure and the inclination of the pillar top surface of the column-type directing structure are not limited to the descriptions above. In another embodiment, according to the distance between the head-mounted display system 100 and the eye pupil of the user while the user wears the head-mounted display system (as shown in FIG. 1), the heights of the column-type directing structures and the inclinations of the pillar top surfaces of the column-type directing structures are adjusted. That is, when the user wears the head-mounted display system 100, by using the user pupil closest to the head-mounted display system 100 as the basis, the more the column-type directing structure far away from the user pupil is, the smaller the height of the column-type directing structure is. Further, the more the column-type directing structure close to the user pupil is, the larger the height of the column-type directing structure is. In the other embodiment, when the user wears the head-mounted display system 100, by using the user pupil closest to the head-mounted display system 100 as the basis, the more the column-type directing structure far away from the user pupil is, the larger the inclination of the pillar top surface of the column-type directing structure to the display surface is. Further, the more the column-type directing structure close to the user pupil is, the smaller the inclination of the pillar top surface of the column-type directing structure to the display surface is.

In addition, the pointing unit top surface 316 of the display pointing unit 306 which is formed by the pillar top surfaces 314a of the column-type directing structures can be, for example, the discontinuous convex surface as shown in FIG. 3A (such as the discontinuous convex lens surface) or the continuous smooth convex surface as shown in FIG. 3B (such as the continuous smooth convex lens surface). Moreover, the heights of the column-type directing structures 314 are not limited to the descriptions of the previous embodiment in which the heights of the column-type directing structures 314 vary with the arrangement positions of the corresponding pixels 304b. FIG. 3C is a schematic cross-sectional diagram showing a display unit and a display pointing unit according to one embodiment of the invention. As shown in FIG. 3C, the body heights h′ of the main pillar bodies 314b of the column-type directing structures 314 are the same. It should be noticed that the inclinations of the pillar top surfaces 314a of the column-type directing structures 314 vary with the arrangement positions of the corresponding pixels 304b so that the heights h″ of the triangular prisms 314c respectively on the main pillar bodies 314b vary with the arrangement positions of the corresponding pixels 304b. Therefore, the contour of the display pointing unit 306 shows that the whole pointing unit top surface 316 of the display pointing unit 306 is a zigzag rough surface. FIG. 3D is a schematic cross-sectional diagram showing a display unit and a display pointing unit according to one embodiment of the invention. As shown in FIG. 3D, in another embodiment, the total heights of the column-type directing structures 314 are equal to each other. That is, with the different arrangement positions of the corresponding pixels 304b, the body heights h′ of the main pillar bodies 314b of the column-type directing structures 314 and the heights h″ of the triangular prisms 314c respectively on the main pillar bodies 314b vary respectively and the total heights of the column-type directing structures 314 which respectively is the sum of the body height h′ of the corresponding main pillar body 314b and the height h″ of the corresponding triangular prism are equal to each other. The inclinations of the pillar top surfaces 314a of the column-type directing structures 314 vary with the different arrangement positions of the corresponding pixels 304b. Therefore, in the embodiment shown in FIG. 3D, the contour of the display pointing unit 306 shows that the whole pointing unit top surface 316 of the display pointing unit 306 is a zigzag rough surface.

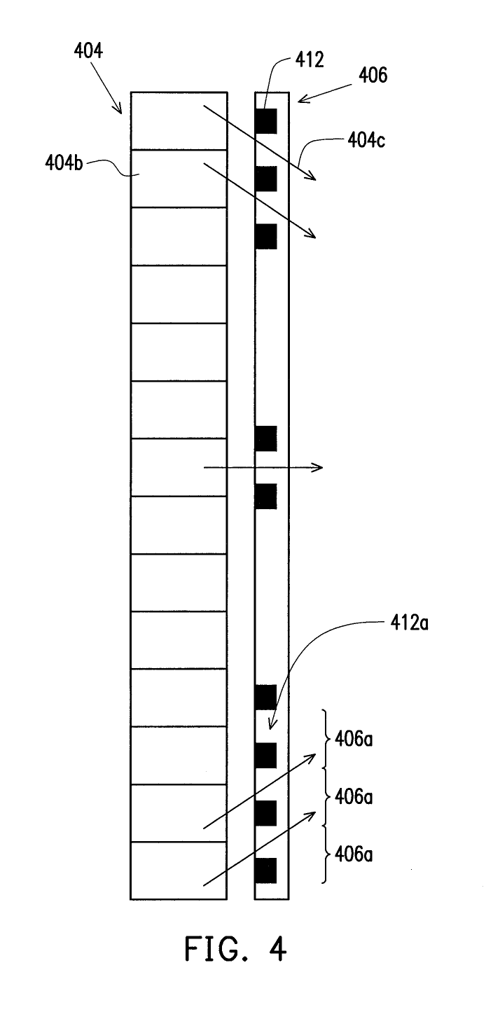

FIG. 4 is a schematic cross-sectional diagram showing a display unit and a display pointing unit according to another embodiment of the invention. As shown in FIG. 4, in this embodiment, each of the pointing structures comprises a shielding structure 412 for shielding a portion of the image beams from the corresponding pixel. In the present embodiment, to clearly describe the present invention, a single pointing structure is used for performing individual and particular shielding process on the image beam from the corresponding pixel. However, the display pointing unit of the present invention is not limited to the object comprised of several pointing structures as mentioned in the previous embodiment. In other words, the display pointing unit 406 can be, for example, a one-piece light directing unit having several shielding structures 412 and, according to the arrangement positions of the pixels 404b, the display pointing unit 406 are divided into several pointing structures 406a respectively corresponding to the pixels 404b.

In the present embodiment, each of the shielding structures 412 shields a portion of the image beams 404c from the corresponding pixels 404b so that the rest portion of the image beams 404c with a particular traveling direction passes through the shielding structure 412. In other words, each of the shielding structure 412 has a transparent aperture 412a. With the different arrangement positions of the pixels 404b on the display unit 404 respectively corresponding to the pointing structures 406a, the arrangement positions of the transparent apertures 412a of the shielding structures 412 are different from each other. That is, the portion of the image beams 404c passing through the shielding structures have different particular light traveling directions according to the arrangement positions of the pixels 404b on the display unit 404 respectively corresponding to the shielding structures 412. Accordingly, by using this display pointing unit 406, the portion of the image beams passing through the shielding structures 412 can be directed to one pupil of at least one of the eyes of the user. More specifically, each of the particular light traveling directions is toward the pupil of at least one of the eyes of the user. Moreover, the shielding structures 412 of the display pointing unit 406 of the present embodiment not only respectively direct the image beams from the display unit but also shrinks the image beams 404c respectively passing through the shielding structures 412 to be within a particular range. For instance, after the image beams respectively pass through the pointing structures 406a, the scattering angle of each of the image beams is smaller than 0.1 degree.

In another embodiment, the aforementioned shielding structures 412 comprise liquid crystal structures. In the present embodiment, the head-mounted display system 100 (as shown in FIG. 1) further comprises a pupil position detector 160. The pupil position detector 160 is used for detecting a pupil position of the at least one of the eyes of the user. Hence, when the pupil position detector 160 detects the change of the pupil position of the pupil of the user eye, the controller 102 coupled to the pupil position detector 160 controls a lattice orientation of each of the liquid crystal structures of the display pointing unit 106 according to the pupil position detected by the pupil position detector so that the portion of the image beams passing through each of the liquid crystal structures are respectively directed to the pupil of at least one of the eyes of the user.

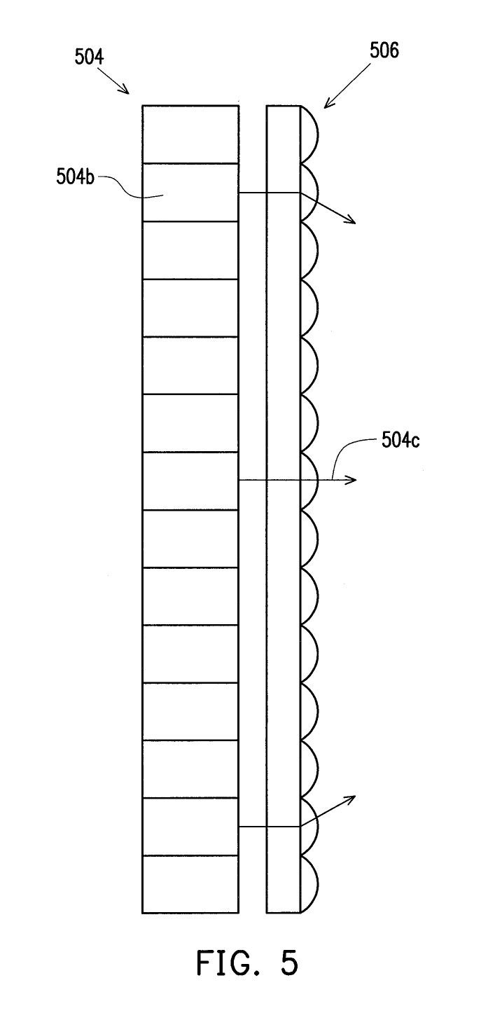

FIG. 5 is a schematic cross-sectional diagram showing a display unit and a display pointing unit according to the other embodiment of the invention. As shown in FIG. 5, each of the pointing structures of the display pointing unit 506 in the present embodiment can be a transparent lens for converging/focusing the image beam 504c from the corresponding pixel 504b and direct the converged/focused image beam to the pupil of at least one of the eyes of the user. Each of the transparent lens can be, for example, a convex lens. Moreover, the scattering angle of each of the image beams passing through the corresponding transparent lens is smaller than 0.1 degree.

In the display unit of the present invention, before entering the user pupil of the user, the image beam emitted from each of the pixels is optically processed by the display pointing unit so that the image beam is shrunk and the scattering angle of each of the image beam is within a particular range. Further, the light traveling direction of each of the image beams which have been optically processed is toward the user pupil. Then, after being refracted by the crystalline lens of the user, the shrunken image beams compose a distinct image on the retina. Therefore, although the distance between the display unit of the head-mounted display system 100 and the eyeball of the user is short, the user can still receive the clear image and there is no need to adjust the focal length of the crystalline lens. Hence, the user will not feel tired or even suffers from eye injury by using the head-mounted display system for a long time.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A head-mounted display system for a user to wear on, comprising:
a display unit, wherein the display unit has a display surface facing a face of the user and is comprised of a plurality of pixels and each of the pixels emits an image beam; and
a display pointing unit configured on the display surface of the display unit, wherein the display pointing unit shrinks the image beams from the pixels and directs the shrunk image beam towards a pupil of at least one of eyes of the user.

2. The head-mounted display system of claim 1, wherein the display pointing unit comprises a plurality of pointing structures and each of the pointing structures corresponds to at least one of the pixels.

3. The head-mounted display system of claim 2, wherein each of the pointing structures comprises a shielding structure for shielding a portion of the image beams from the corresponding pixel.

4. The head-mounted display system of claim 3, wherein each of the pointing structures further comprises a column-type directing structure arranged to be corresponding to the shielding structure of the pointing structure and each of the column-type directing structure directs the image beam passing through the corresponding shielding structure to the pupil of the at least one of the eyes of the user.

5. The head-mounted display system of claim 4, wherein pillar top surfaces of the column-type directing structures have different inclinations to the display surface according to arranging positions of the corresponding pixels on display unit.

6. The head-mounted display system of claim 5, wherein the column-type directing structures have different pillar heights according to the arranging positions of the corresponding pixels on display unit.

7. The head-mounted display system of claim 5, wherein the pillar top surfaces of the column-type directing structure together form a pointing unit top surface of the display pointing unit and there is an inclination angle between the pointing unit top surface and the display surface.

8. The head-mounted display system of claim 3, wherein a scattering angle of each of the image beams passing through each of the pointing structures is smaller than 0.1 degree.

9. The head-mounted display system of claim 3, wherein each of the shielding structure shields the portion of the image beams from the corresponding pixel so that rest portion of the image beams with a particular light traveling direction passes through the shielding structure.

10. The head-mounted display system of claim 9, wherein a portion of the image beams passing through the shielding structures have different particular light traveling directions according to arranging positions of the corresponding pixels on display unit.

11. The head-mounted display system of claim 9, wherein each of the particular light traveling directions points to the pupil of the at least one of the eyes of the user.

12. The head-mounted display system of claim 9, wherein a scattering angle of each of the image beams passing through each of the pointing structures is smaller than 0.1 degree.

13. The head-mounted display system of claim 9, wherein each of the shielding structures includes a liquid crystal structure.

14. The head-mounted display system of claim 13, further comprising:
a pupil position detector for detecting a pupil position of the at least one of the eyes of the user; and
a controller connected to the display pointing unit and the pupil position detector, wherein, according to the pupil position detected by the pupil position detector, a lattice orientation of each of the liquid crystal structures of the display pointing unit is controlled so that a portion of the image beams passing through each of the liquid crystal structures respectively points to the pupil of the at least one of the eyes of the user.

15. The head-mounted display system of claim 2, wherein each of the pointing structures includes a lens for focusing the image beam from the corresponding pixel and directing the focused image beam to the pupil of the at least one of the eyes of the user.

16. The head-mounted display system of claim 15, wherein a scattering angle of each of the image beams passing through each of the pointing structures is smaller than 0.1 degree.
